(19) United States
(12) Patent Application Publication
(10) Pub. No.: US 2010/0238990 A1
(43) Pub. Date: Sep. 23, 2010

(54) Methods for indentifying errant channel reporting devices

(76) Inventor: Anil M. Rao, Wheaton, IL (US)

Correspondence Address: Alcatel-Lucent USA Inc.;Docket Administrator, Room 2F-192, 600-700 Mountain Ave., Murray Hill, NJ, 07974-0636, US

(21) Appl. No.: 12/383,101

(22) Filed: Mar. 19, 2009

(51) Int. Cl. H04B 17/00

(52) U.S. Cl. 375/228

(57) ABSTRACT

To address the need for new techniques that enable the identification of errant channel reporting devices, various embodiments are described. In some embodiments, a network node receives (201, 401) channel quality indicators (CQI) from user equipment (UE) via a connection and determines (202, 402) whether the CQI are erroneous. In response to determining that the CQI are erroneous, the network node records (203) a timestamp and a connection identifier corresponding to the connection between the UE and the network node. In other embodiments, the network node, in response to determining that the CQI are erroneous, records (403) a device hardware identifier for the UE. In the various embodiments, information is recorded and/or obtained and distributed in a manner that enables the identification of errant channel reporting devices within a communication system.

### FIELD OF THE INVENTION

The present invention relates generally to communication systems and, in particular, to identifying errant channel reporting devices.

### BACKGROUND OF THE INVENTION

In wireless technologies, such as LTE (Long Term Evolution), user equipment (UE) devices report channel quality indicators (CQI) that are used by the network to allocate system resources among the system users. Some UE devices are known to report erroneous CQI. Such reporting can degrade system performance and potentially affect the system's ability to fully service other users. Thus, a need exists, particularly among system operators, for new techniques that enable the identification of errant channel reporting devices.

### BRIEF DESCRIPTION OF THE DRAWINGS

FIG. 1 is a logic flow diagram of functionality performed by network equipment in accordance with various embodiments of the present invention.

FIG. 2 is a logic flow diagram of functionality performed by a network node in accordance with various embodiments of the present invention.

FIG. 3 is a logic flow diagram of functionality performed by network equipment in accordance with various embodiments of the present invention.

FIG. 4 is a logic flow diagram of functionality performed by a network node in accordance with various embodiments of the present invention.

FIG. 5 is an exemplary signaling flow diagram that depicts an initial attach procedure between a UE and various network devices in accordance with particular detailed embodiments of the present invention.

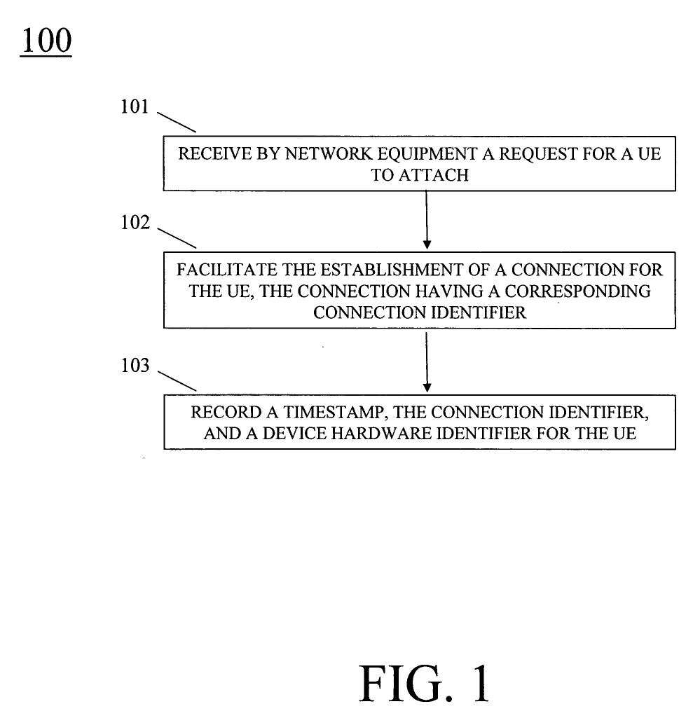

Specific embodiments of the present invention are disclosed below with reference to FIGS. 1-5. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

To address the need for new techniques that enable the identification of errant channel reporting devices, various embodiments are described. In some embodiments, a network node receives channel quality indicators (CQI) from user equipment (UE) via a connection and determines whether the CQI are erroneous. In response to determining that the CQI are erroneous, the network node records a timestamp and a connection identifier corresponding to the connection between the UE and the network node. In other embodiments, the network node, in response to determining that the CQI are erroneous, records a device hardware identifier for the UE.

Embodiments for other network equipment are also described. In some embodiments, network equipment receives a request for user equipment (UE) to attach. The establishment of a connection for the UE is facilitated and a timestamp, a connection identifier (corresponding to the connection), and a device hardware identifier for the UE are all recorded.

In other embodiments, network equipment receives a request for user equipment (UE) to attach and obtains a device hardware identifier for the UE. The network equipment then sends an indication of the device hardware identifier to the network node.

In the various embodiments, information is recorded and/or obtained and distributed in a manner that enables the identification of errant channel reporting devices within a communication system.

### DETAILED DESCRIPTION OF EMBODIMENTS

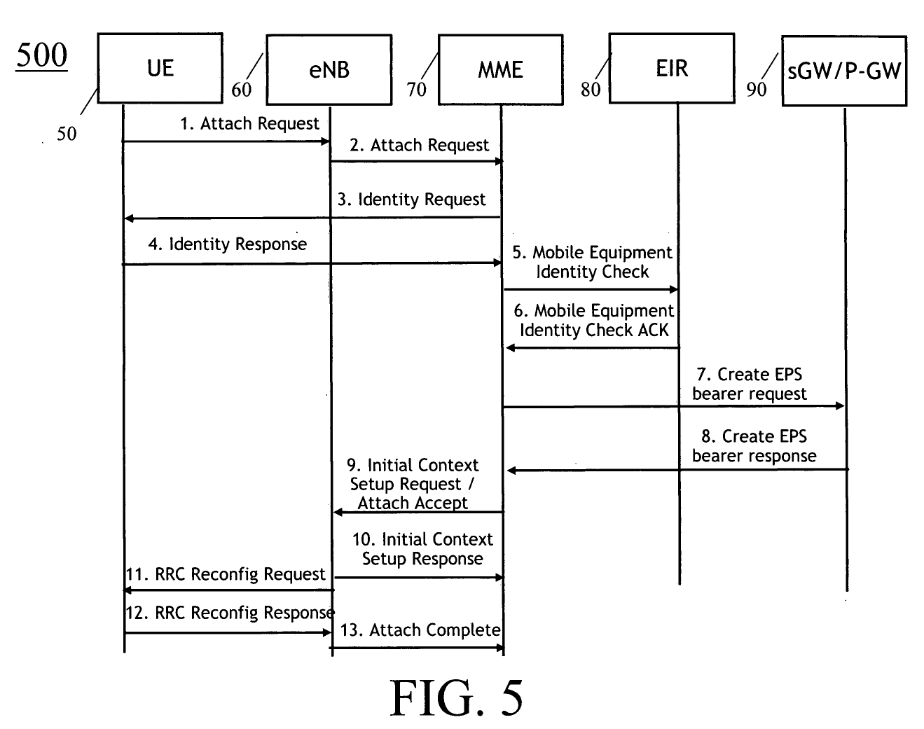

To provide a greater degree of detail in making and using various aspects of the present invention, a description of certain, quite specific, embodiments follows for the sake of example. FIG. 5 is an exemplary signaling flow diagram that depicts an initial attach procedure between a UE and various network devices in accordance with particular detailed embodiments of the present invention.

Diagram 500 depicts UE 50 attempting to attach to network equipment such as that in an LTE network. UE 50 is able to wirelessly communicate with network nodes such as evolved Node-B (eNB) 60. eNB 60 has network connectivity with network equipment such as Mobility Management Entity (MME) 70, while MME 70 has signaling connectivity with other core network equipment such as Equipment Identity Register (EIR) 80 and Serving Gateway (sGW)/Packet Data Network Gateway (P-GW) 90.

The operator of a system such as that depicted in diagram 500 desires to identify devices that are reporting erroneous channel quality indicators (CQI) which can disrupt the operation of their network. The operator would like the base station (e.g., eNB) to determine which devices are reporting bad CQI (so called “worst offender devices”) and identify them by their IMEI (international mobile equipment identity). The IMEI of a UE is associated with its device hardware rather than a SIM card that may be inserted into the UE. At present, a base station is the only entity that has access to the reported CQI values from its connected devices; however, the base station is not aware of the IMEIs of these connected devices.

Signaling flow diagram 500 depicts an initial attach procedure that takes place in certain embodiments when a UE powers on. The signaling flow is summarized below:
1. UE sends an attach request to the eNB upon powering on.
2. The eNB forwards the attach message to the MME.
3. The MME sends a non-access stratum (NAS) message to the UE to request its IMEI.
4. The UE responds with its IMEI, which is a 15-bit number unique to the device hardware.
5. The MME checks with the Equipment Identity Register (EIR) to determine whether this device can connect to the network (e.g., to check whether the device has been flagged as stolen/lost, etc.).
6. The EIR responds with an acknowledgment if the UE is allowed to connect to the network, and the attach procedure continues.
7. The MME requests an EPS (evolved packet system) bearer be created for this UE to the sGW/P-GW.
8. The sGW/P-GW responds that a bearer can be created.
9. The MME sends an initial context setup request message to the eNB which provides the eNB with the information about the bearer, including an assigned E-RAB ID (EPS radio access bearer ID). The E-RAB ID uniquely identifies the connection of the UE with the core network.
10. The eNB responds with an acknowledgement of the context setup.
11. The eNB sends a RRC reconfiguration request to the UE to configure the parameters of the EPS bearer.
12. The UE sends a response to the RRC reconfiguration request.
13. The eNB sends a message to the MME to signal that the attach procedure has been completed.

One way to provide the IMEIs of worst offender devices reporting bad CQI values is to generate logging information at the eNB which writes out the E-RAB ID corresponding to the worst offender devices together with a time stamp. The E-RAB ID uniquely identifies the connection of an end user device with the eNB all the way through the serving gateway (sGW) in the core network. The mobility management entity (MME) in the core network is responsible for assigning the E-RAB ID, and the MME is aware of the IMEI from the initial attach procedure (as described above with respect to signaling 4). Therefore, a logging mechanism is also in the MME which writes out the E-RAB ID and the IMEI together with a time stamp each time an EPS bearer is created.

In this way, an operator can compare the eNB and MME logs to determine the IMEI of the worst-offender devices. Note that the time stamp is needed because the E-RAB ID is only a temporary identifier that may be reused. When a user disconnects from the network and then reconnects, it usually gets assigned a new E-RAB ID.

Another more direct way to provide the IMEIs of worst offender devices involves providing the UE IMEIs to the base stations. For example, the IMEI may be provided directly from the MME to the eNB through the S1-MME interface as part of the initial context setup request message. As presently defined in 3GPP TS 36.413, the initial context setup request message does not convey the IMEI to the eNB. Thus, a change to the initial context setup request message is proposed whereby IMEI information for the UE may be indicated to a base station receiving signaling 9 in diagram 500. Specifically, we propose adding the IMEI field to the initial context setup request message. The eNB would then be directly aware of the IMEI and could simply log the IMEI of the worst offender devices for the operator.

Before logging either the E-RAB ID and timestamp or the IMEI for worst offender devices, the base station determines that a device is reporting erroneous CQI values. One way the base station may do this is to compare the MCS (modulation and coding scheme) a device is able to handle to maintain a prescribed error rate (for example a 10% error rate on its first transmission). An internal look up table, for example, could contain a mapping between the reported CQI value and a range of MCS levels that could support the prescribed error rate (the reasons a range is necessary is because it can vary due to different fading channel conditions). Based on the ACK/NACK feedback from the device, the base station can compute the error rate the device is achieving for a particular MCS level for the CQI values that the device is reporting. If it falls substantially outside the range of the internal look up table, the base station can classify this device as a worst offender with erroneous CQI reports and log it for the operator.

Generally speaking, two approaches have been described above. The first approach can be summarized as follows:
Provide a logging mechanism at the base station to report the E-RAB ID along with a time stamp when it detects devices reporting erroneous CQI.
Provide a logging mechanism at the MME which reports the IMEI and the E-RAB ID along with a time stamp for each EPS bearer that is established.
An operator may then combine the eNB and MME logs to determine the IMEI of the devices reporting erroneous CQI.

The second approach can be summarized as follows:
Add the IMEI as a field in the INITIAL CONTEXT SETUP REQUEST message which is passed from the MME to the eNB across the S1-MME interface upon establishment of a data session. The eNB is then aware of the IMEI while the UE retains its RRC connection to the base station.
The logging provided by the eNB would then directly report the IMEI of devices that it determines are reporting erroneous CQI.

The detailed and, at times, very specific description above is provided to effectively enable a person of skill in the art to make, use, and best practice the present invention in view of what is already known in the art. In the examples, specific architectures, specific message names, specific message field values, specific messaging formats, and specific messaging sequences are all provided for the purpose of illustrating possible embodiments of the present invention and should not be interpreted as restricting or limiting the scope of the broader inventive concepts.

The present invention can be more broadly understood with reference to FIGS. 1-4. FIGS. 1-4 depict functionality performed by network equipment and network nodes in accordance with various embodiments of the present invention.

It should be understood that wireless communication systems typically include a plurality of UEs, a plurality of network nodes, and additional network equipment; however, FIGS. 1-4 typically make reference to only a single UE and/or single network node for the sake of clarity and simplicity in description. Also, UE platforms are known to span a wide variety of consumer electronic platforms such as, but not limited to, Voice over IP (VoIP) phones, mobile stations (MSs), access terminals (ATs), terminal equipment, mobile devices, gaming devices, personal computers, personal digital assistants (PDAs), and any other mobile equipment capable of being used in a wireless system. Network nodes are network elements that provide over the air communication with UEs. For example, depending on the technologies involved, a network node may be embodied in-part or in-full as, or within, a base station, an access point, and/or an access network.

FIG. 1 is a logic flow diagram of functionality performed by network equipment in accordance with various embodiments of the present invention. In the method depicted in diagram 100, network equipment receives (101) a request for a UE to attach. In some embodiments, an MME receives this request from the UE via a network node such as an eNB; however, the network equipment need not be an MME. The network equipment facilitates (102) the establishment of a connection for the UE in accordance with the applicable network signaling protocols. Diagram 500 illustrates an example of such signaling. In some embodiments, the network equipment The connection that is established has a corresponding connection identifier such as an evolved packet system radio access bearer ID (E-RAB ID).

The network equipment may additionally (or as part of facilitating the connection establishment) send a request for identification of the UE. In response to this request, the network equipment may receive a device hardware identifier from the UE, such as its IMEI (international mobile equipment identity). Having the information that it needs, the network equipment records (103) the connection identifier and the device hardware identifier for the UE along with a current timestamp. It may record this information by any of a variety of known techniques. For example, the information may be written to a log file, sent to another network device for storage/collection, etc.

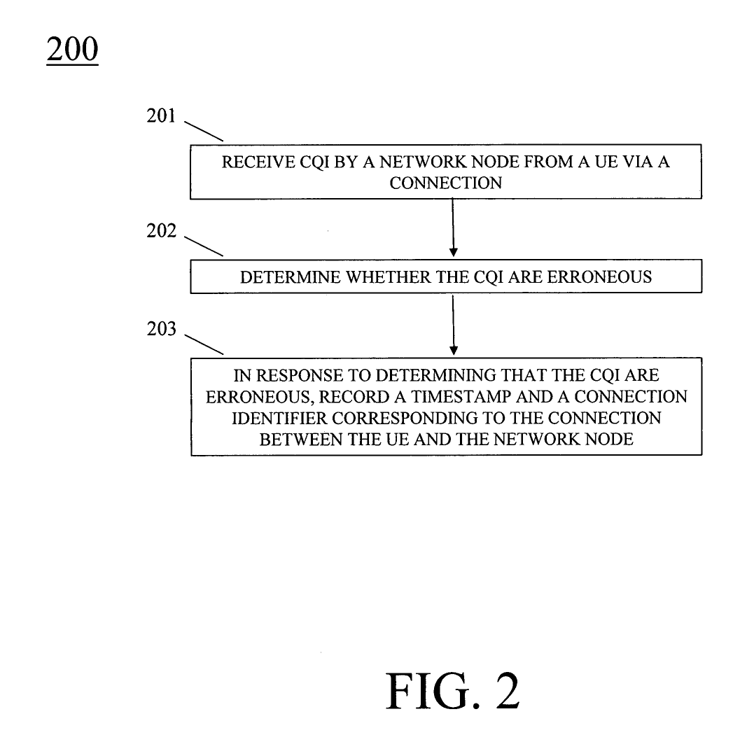

FIG. 2 is a logic flow diagram of functionality performed by a network node in accordance with various embodiments of the present invention. In the method depicted in diagram 200, the network node receives (201) channel quality indicators (CQI) from a UE via an established connection. The network node then determines (202) whether the CQI are erroneous. In some embodiments, when the CQI are determined erroneous, the network node records (203) (by any of a variety of known techniques) a connection identifier corresponding to the connection between the UE and the network node and a current timestamp. This connection identifier may be an E-RAB ID, as mentioned before.

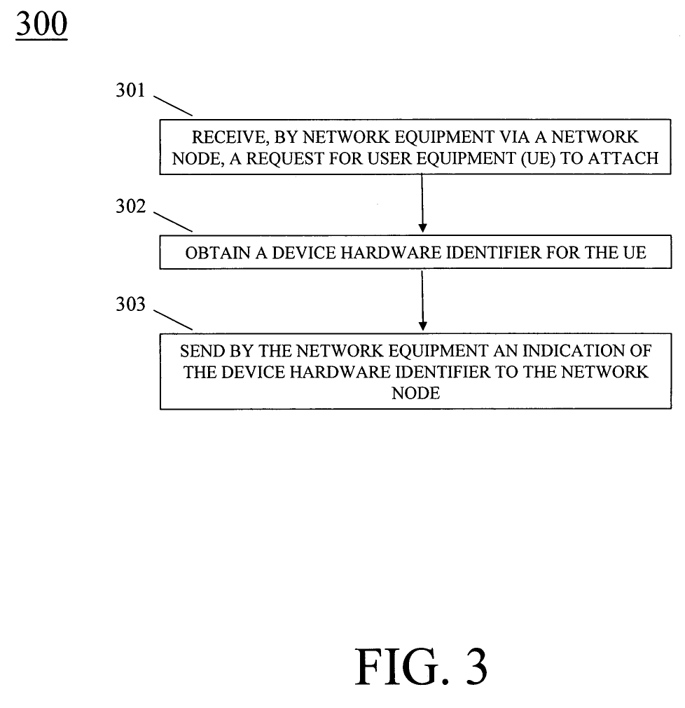

FIG. 3 is a logic flow diagram of functionality performed by network equipment in accordance with various embodiments of the present invention. In the method depicted in diagram 300, network equipment receives (301) a request for a UE to attach. In some embodiments, an MME receives this request from the UE via a network node such as an eNB; however, the network equipment need not be an MME.

The network equipment also obtains (302) a device hardware identifier for the UE. To obtain this, the network equipment may send a request for identification of the UE. In response to this request, the network equipment may receive a device hardware identifier from the UE, such as its IMEI (international mobile equipment identity). The network equipment then sends (303) an indication of the device hardware identifier to the network node. It may send a message to the network node that includes the device hardware identifier itself, such as described above with respect to diagram 500, or it may convey the identifier in some less explicit way.

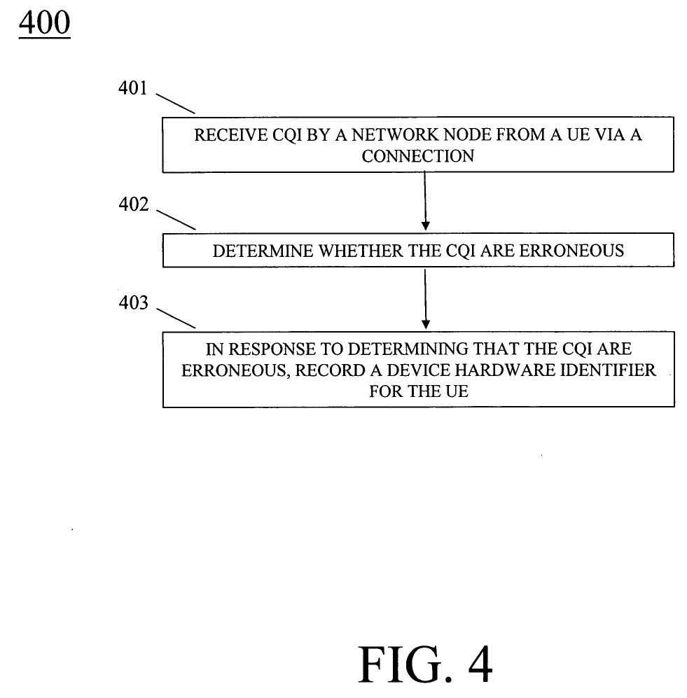

FIG. 4 is a logic flow diagram of functionality performed by a network node in accordance with various embodiments of the present invention. In the method depicted in diagram 400, the network node receives (401) channel quality indicators (CQI) from a UE via an established connection. The network node then determines (402) whether the CQI are erroneous. In some embodiments, when the CQI are determined erroneous, the network node records (403) (by any of a variety of known techniques) a device hardware identifier for the UE. This device hardware identifier may be an IMEI, as mentioned before.

Depending on the embodiment, the network node may have the IMEI of the UE from some prior communication. For example, the network node may receive the device hardware identifier from the UE during some initialization or attachment-related signaling. In other embodiments, the network node may receive the device hardware identifier from network equipment, such that described with respect to diagram 300.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some part or portion of the object/information being indicated, the conveyance of some derivation of the object/information being indicated, and the conveyance of some symbol representing the object/information being indicated.

What is claimed is:

1. A method for identifying errant channel reporting devices comprising:
receiving channel quality indicators (CQI) by a network node from user equipment (UE) via a connection;
determining whether the CQI are erroneous;
in response to determining that the CQI are erroneous, performing at least one of
recording a timestamp and a connection identifier corresponding to the connection between the UE and the network node or
recording a device hardware identifier for the UE.

2. The method as recited in claim 1, further comprising:
receiving the device hardware identifier for the UE.

3. The method as recited in claim 2, wherein receiving the device hardware identifier comprises
receiving by the network node the device hardware identifier from the UE.

4. The method as recited in claim 2, wherein receiving the device hardware identifier comprises
receiving by the network node the device hardware identifier from network equipment.

5. The method as recited in claim 4, wherein the network equipment comprises a mobility management entity (MME).

6. The method as recited in claim 1, wherein recording the timestamp and the connection identifier comprises
recording the timestamp and the connection identifier to a log.

7. The method as recited in claim 1, wherein recording the device hardware identifier for the UE comprises
recording the device hardware identifier for the UE to a log.

8. The method as recited in claim 1, wherein the network node comprises an evolved Node-B (eNB).

9. The method as recited in claim 1, wherein the device hardware identifier for the UE comprises the IMEI (international mobile equipment identity) of the UE.

10. The method as recited in claim 1, wherein the connection identifier corresponding to the connection between the UE and the network node comprises an evolved packet system radio access bearer ID (E-RAB ID).

11. A method for identifying errant channel reporting devices comprising:
receiving by network equipment a request for user equipment (UE) to attach;
facilitating the establishment of a connection for the UE, the connection having a corresponding connection identifier;
recording a timestamp, the connection identifier, and a device hardware identifier for the UE.

12. The method as recited in claim 11, further comprising:
sending a request for identification of the UE;
in response to the request, receiving the device hardware identifier from the UE.

13. The method as recited in claim 11, wherein recording the timestamp, the connection identifier and the device hardware identifier for the UE comprises
recording by the network equipment the timestamp, the connection identifier and the device hardware identifier to a log.

14. The method as recited in claim 11,
wherein the device hardware identifier for the UE comprises the IMEI (international mobile equipment identity) of the UE and
wherein the connection identifier corresponding to the connection between the UE and the network node comprises an evolved packet system radio access bearer ID (E-RAB ID).

15. A method for identifying errant channel reporting devices comprising:
receiving, by network equipment via a network node, a request for user equipment (UE) to attach;
obtaining a device hardware identifier for the UE;
sending by the network equipment an indication of the device hardware identifier to the network node.

16. The method as recited in claim 15, wherein sending by the network equipment an indication of the device hardware identifier to the network node comprises
sending a message that includes the device hardware identifier to the network node.

17. The method as recited in claim 16, wherein the message comprises a context setup request message that includes a field for an IMEI (international mobile equipment identity).

18. The method as recited in claim 15, wherein obtaining a device hardware identifier for the UE comprises:
sending a request for identification of the UE;
in response to the request, receiving the device hardware identifier from the UE via the network node.

19. The method as recited in claim 15,
wherein the network equipment comprises a mobility management entity (MME) and
wherein the network node comprises an evolved Node-B (eNB).

20. The method as recited in claim 15, wherein the device hardware identifier for the UE comprises the IMEI (international mobile equipment identity) of the UE.
